(19) United States
(12) Patent Application Publication
(10) Pub. No.: US 2026/0023828 A1
(43) Pub. Date: Jan. 22, 2026

(54) AI LINEAGE SYSTEM WITH BLOCKCHAIN INTEGRATION

(71) Applicant: Eric Charran, Doylestown, PA (US)

(72) Inventor: Eric Charran, Doylestown, PA (US)

(21) Appl. No.: 19/272,574

(22) Filed: Jul. 17, 2025

Related U.S. Application Data
(60) Provisional application No. 63/672,491, filed on Jul. 17, 2024.

(51) Int. Cl. G06F 21/16; G06F 21/60; G06F 21/64

(52) U.S. Cl. CPC G06F 21/16; G06F 21/602; G06F 21/64

(57) ABSTRACT

A comprehensive system for tracking, visualizing, and analyzing the lineage of datasets and artificial intelligence (AI) models using blockchain technology. The system attests, registers, and records datasets and AI models on a blockchain-based infrastructure, ensuring they are immutable, discoverable, and searchable. It enables real-time notifications for anomalies and key lineage events, supports integration with machine learning operations (MLOps) pipelines, and enhances data ownership, visibility, and accountability. Through a robust API layer, the system interoperates with hyperscalers and platform providers and includes a consumer-focused analytical and configuration management plane. Equipped with lineage-aware machine learning intelligences, the system delivers intelligent lineage insights that improve confidence and transparency in AI inferences and data usage across enterprise and open-source environments.

### CROSS REFERENCE TO RELATED APPLICATIONS

This application claims priority from a U.S. Provisional Patent Appl. No. 63/672,491, filed on Jul. 17, 2025, which is incorporated herein by reference in its entirety.

### FIELD OF INVENTION

The present invention relates to data lineage and blockchain technologies, and more particularly, to a system and method for AI model and dataset lineage tracking with blockchain integration, enabling compliance, integrity, and transparency throughout the AI lifecycle.

### BACKGROUND

In recent years, artificial intelligence (AI) and machine learning (ML) have become integral to various industries, driving innovation and operational efficiency. However, challenges persist in tracing the provenance and transformation of datasets and AI models, verifying data integrity, and ensuring auditability and transparency across AI workflows. These limitations hinder the ability to verify model outcomes, validate ethical use, and comply with data governance regulations.

Traditional systems lack comprehensive mechanisms for immutable tracking, anomaly response, and regulatory attestation. Moreover, as AI continues to be embedded in digital experiences, it is critical to provide end-to-end traceability and trust mechanisms that support public accountability and regulatory scrutiny.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The principal object of the present invention is to provide a secure, traceable, and auditable AI lineage platform using a multi-layered blockchain framework, federated learning compatibility, anomaly detection, and compliance enforcement mechanisms.

It is an object of the invention to ensure that all authorized actions within the system are verifiable, reproducible, and compliant with pre-defined lineage policies, while maintaining interoperability across diverse AI development environments and platforms.

Another object of the invention is to enhance accountability and transparency in the development and deployment of AI models by recording and exposing lineage-related events and decisions.

A further object is to deliver real-time responsiveness backed by blockchain-based trust mechanisms, ensuring tamper-resistant records of key events and transactions.

Yet another object of the invention is to enable real-time anomaly detection and system feedback by monitoring events, data changes, and model behavior.

An additional object is to provide immutable, tamper-evident audit trails suitable for regulatory oversight and independent verification by auditors or stakeholders.

Another object is to support cross-party verification and end-to-end system state tracing, thereby facilitating collaborative development and multi-stakeholder compliance.

In one aspect, the invention discloses a system based on blockchain and cryptographic techniques that records an immutable history of AI system behavior over time. The system supports verification of data and model lineage, detection of manipulation attempts through monitoring of changes in model parameters and data fingerprints, and identification of anomalous events. Each anomaly, transaction, or significant event results in the creation of a new versioned record, forming a verifiable and tamper-resistant audit trail.

The principal object of the present invention is to provide a secure, traceable, and auditable AI lineage platform using a multi-layered blockchain framework, federated learning compatibility, anomaly detection, and compliance enforcement mechanisms.

In one embodiment, the invention discloses a dynamic anomaly detection and correction engine; a multi-layered blockchain architecture separating lineage-critical data by type (e.g., operational events, inference telemetry, anomaly/correction logs, compliance artifacts); federated learning-compatible lineage tracking; smart contracts to enforce lineage governance policies across systems; adaptive, role-based user interfaces for lineage visualization; and secure hash-based attestation and provenance tracking using SHA-256 and Merkle tree structures. The system further enables real-time alerting, correction logging, and end-to-end system state verification.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a high-level block diagram of the AI lineage system architecture, including user interface, data management, model management, and compliance subsystems.

FIG. 2 illustrates a layered blockchain-integrated software architecture featuring specialized modules for interface, registration, attestation, tracking, training data lineage, inference traceability, and anomaly remediation.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The scope of the invention will be defined by the claims of any issued patent.

The present invention relates to a blockchain-based data lineage system designed to address the critical need for transparency, traceability, and auditability in the development and deployment of artificial intelligence (AI) models. The system provides a structured and reliable method for tracking the complete lineage of datasets, features, model versions, hyperparameters, and outputs throughout the AI lifecycle. The architecture is organized into four integrated components: (1) User Interface, (2) Data Management, (3) AI Model Management, and (4) Security and Compliance.

The invention provides a comprehensive and intelligent framework for tracking, visualizing, and analyzing the lineage of datasets and AI models using blockchain technology. A key feature of the system includes lineage intelligence, which detects and alerts users to material changes in the attributes of datasets and AI models. These alerts enable interested parties to receive real-time notifications and event updates when modifications occur, including the ability to detect and respond to undesired or anomalous changes. All datasets and AI models are attested, registered, and continuously tracked within a blockchain-based infrastructure, ensuring immutability and enabling discoverability and advanced search.

The system enables proactive user notifications triggered by detected anomalies or other significant lineage events. It is designed for seamless integration into existing machine learning operations (MLOps) pipelines, thereby enhancing governance, ownership, visibility, and operational responsibility across AI workflows.

The system also interoperates with hyperscalers and third-party AI development platform providers via a robust application programming interface (API) layer. A consumer-focused analytical and configuration management plane is included, alongside a suite of lineage-aware machine learning intelligences. This combination forms a unified platform for smart lineage experiences, significantly improving the trust, transparency, and explainability of AI inferences.

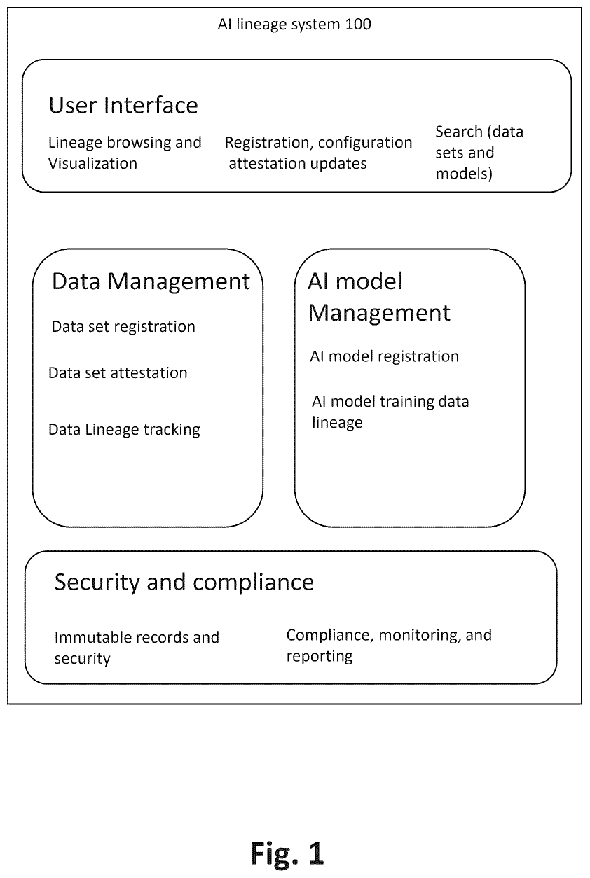

Referring now to FIG. 1, the system architecture comprises four major components that collectively fulfill the objectives of the invention: (1) User Interface, (2) Data Management, (3) AI Model Management, and (4) Security and Compliance.

The User Interface component provides intuitive tools for lineage browsing and visualization, enhancing system usability and user accessibility. It supports seamless dataset and model registration, configuration updates, and attestation through user-friendly forms and dashboards. Additionally, the interface enables advanced search capabilities across datasets and AI models, thereby improving operational efficiency and user interaction.

The Data Management component enables robust dataset registration, ensuring traceability from the point of inception through all stages of usage and transformation. It incorporates sophisticated attestation mechanisms to verify the authenticity and reliability of datasets prior to use in AI model development. The system captures comprehensive data lineage using cryptographic hashing algorithms, such as Secure Hash Algorithm 256 (SHA-256), to ensure immutability and integrity of data records across the lineage lifecycle.

The AI Model Management component supports the registration and tracking of AI models and their associated metadata, including hyperparameters, model architectures, and version history. This component maintains detailed records of model iterations and changes over time. It further documents the lineage of training datasets used for model development, thereby enabling full reproducibility and transparency. Additionally, it incorporates advanced inference traceability mechanisms that capture and record outputs, contributing to thorough audit trails and interpretability of model behavior.

The Security and Compliance component provides immutable record-keeping using cryptographic techniques and blockchain-based immutability features. This component is designed to support regulatory and governance requirements by integrating compliance monitoring and reporting capabilities that align with existing data privacy and AI regulation frameworks, including the General Data Protection Regulation (GDPR), the California Consumer Privacy Act (CCPA), and the European Union Artificial Intelligence Act (AI Act). Automated real-time monitoring is also included, generating alerts and notifications upon detection of compliance deviations or anomalies.

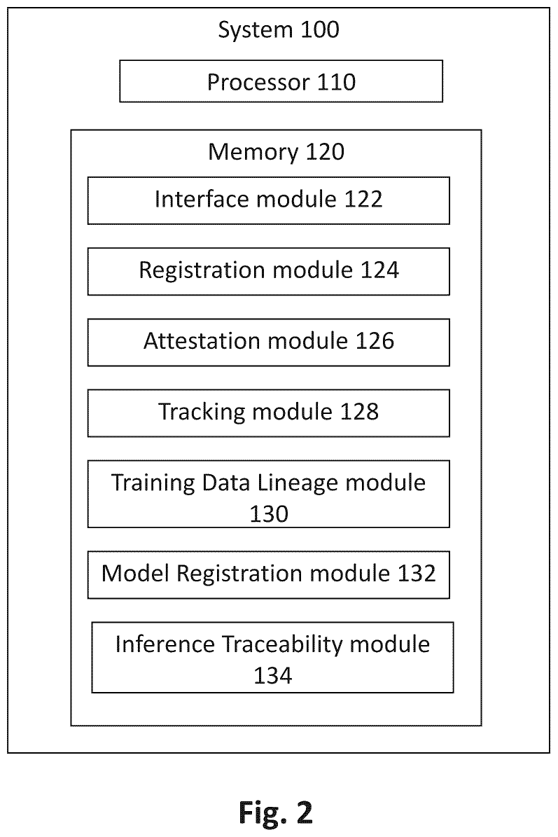

Referring now to FIG. 2, a block diagram illustrates the architecture of the system 100. The system 100 includes a processor 110 and a memory 120 operably coupled to the processor 110. The processor 110 may include any suitable logic circuitry capable of executing instructions retrieved from memory 120. The memory 120 may include one or more non-transitory memory devices, such as DRAM or flash memory, configured to store executable instructions and application data. The memory 120 includes a plurality of software modules for executing steps of the disclosed methodology, including but not limited to: an Interface Module 122, a Registration Module 124, an Attestation Module 126, and a Tracking Module 128.

From a technical implementation standpoint, the system utilizes a blockchain network to record and manage the lineage of datasets and AI models. Each dataset and model instance is treated 2920, accompanied by metadata and a historical log of transformations, modifications, and derivations. The resulting immutable ledger provides a tamper-evident audit trail that ensures long-term data integrity, supports retrospective analysis, and facilitates regulatory or forensic investigations.

The system generates cryptographic hashes for data elements, AI model versions, and lineage events to ensure data integrity and immutability. For example, Secure Hash Algorithm 256 (SHA-256) and Merkle tree hashing techniques may be used to represent the state and content of training data batches, dataset versions, and inference payloads. These hash values are stored on a blockchain, thereby securing the associated data. Any alteration to the underlying data would result in a different hash value, thereby making even the slightest unauthorized change detectable.

### Dataset Management

Technical Process: The system comprises a Registration Module, an Attestation Module, and a Tracking Module. When executed by the processor, these modules facilitate the registration, verification, and tracking of datasets. The Registration Module registers datasets into the system by computing and recording cryptographic hash values for each dataset on the blockchain. Each blockchain entry includes structured metadata comprising details such as: Event type (e.g., training, inference, correction, anomaly), Timestamp, Dataset ID and hash, Model ID and version hash, originating system or service, Inference output or telemetry summary, and Correction rule (if triggered). This structured metadata enables traceability and intelligent querying of lineage records.

The Attestation Module, when executed by the processor, verifies the integrity and authenticity of datasets using cryptographic techniques. Any tampering or unauthorized modification becomes evident due to the resulting change in the dataset's hash value.

The Tracking Module, when executed by the processor, logs all modifications applied to datasets, such as data cleaning, augmentation, or merging. Each modification is treated as a transaction and recorded on the blockchain, thereby producing a comprehensive and immutable lineage trail.

### AI Model Management

In addition to dataset tracking, the system also manages the full lifecycle of AI models. The memory may further include modules such as Training Data Lineage Module 130, Model Registration Module 132, and Inference Traceability Module 134.

The Training Data Lineage Module, when executed by the processor, records the specific datasets, including versions and subsets, used in training each AI model. This linkage provides a direct mapping between models and their training data, supporting reproducibility and auditability.

The Model Registration Module registers AI models along with associated metadata such as training parameters, algorithms used, and performance metrics. All such information is securely recorded on the blockchain, forming an immutable historical record.

The Inference Traceability Module tags each AI inference with corresponding lineage information. This includes links to the datasets and model versions that contributed to the output, enabling users to trace back the exact origin of an AI-generated result.

### Lineage Interface

Technical Process: The system provides a user-friendly interface that allows for dynamic exploration of dataset and model lineage. Through this interface, users can search, filter, and visualize the historical progression of datasets, data transformations, model training iterations, and inference events. The interface also surfaces past lineage-related events—such as detected anomalies or triggered rules—for user awareness and decision-making.

Query Mechanism: The system enables users to perform complex, multi-criteria queries to discover relationships between datasets and AI models. This facilitates the understanding of dependencies, supports data quality analysis, and informs decisions regarding model reliability.

### Security and Compliance

Technical Process: The system incorporates multiple mechanisms to ensure robust security and compliance throughout the AI lifecycle:
Immutable Records: All records are written to a blockchain ledger, ensuring immutability and tamper-resistance, which supports secure and verifiable audit trails.
Access Control: The system employs both attribute-based access control (ABAC) and role-based access control (RBAC) models to manage and restrict user permissions according to organizational policies and data sensitivity.

Compliance Monitoring: The system includes automated compliance monitoring and reporting functions that align with global data governance and regulatory requirements, including GDPR, CCPA, and the EU AI Act.

### Dynamic Anomaly Detection and Correction

Technical Process: The system incorporates an AI-driven dynamic anomaly detection mechanism that identifies and corrects anomalies or inconsistencies in data lineage in real-time. This is achieved through advanced machine learning algorithms trained on historical data lineage patterns. When an anomaly is detected, a correction algorithm using predefined rules and patterns is activated to automatically rectify the inconsistency. This dynamic correction process involves real-time data validation and correction using feedback loops from the anomaly detection models, ensuring a higher level of data integrity and reliability.

### Detection Process

Detection Process: The system continuously monitors data and model lineage records using machine learning algorithms. These algorithms compare real-time lineage data against baseline patterns and thresholds. Upon detecting anomalies, the system categorizes them by severity and generates alerts accordingly.

### Value of Anomaly Detection

Enhanced Data and Model Integrity: Ensuring data lineage and model records are accurate and consistent enhances overall data integrity.

Real-Time Response: Real-time detection minimizes the window of vulnerability, allowing immediate action to prevent the propagation of errors.

Trust and Transparency: Automated detection mechanisms build trust in the data and model lineage system by promptly identifying and addressing inconsistencies.

Regulatory Compliance: Helps meet regulatory compliance by maintaining accurate and reliable lineage records.

Operational Efficiency: Automating the detection and correction of anomalies reduces the need for manual intervention.

Improved Decision-Making: Reliable lineage information supports better decision-making by providing accurate insights into data transformations and model training processes.

### Remediation (Correction Process)

For detected anomalies, the system activates a correction algorithm. The correction algorithm applies predefined rules and patterns to rectify the inconsistency. Corrections are logged as new transactions on the blockchain to maintain a transparent and auditable record. Feedback loops are established to continuously improve the anomaly detection models. Corrected anomalies and their resolutions are used as additional training data to enhance the accuracy and effectiveness of the detection models.

The correction algorithm is AI-governed and continuously monitors lineage events such as data ingestion, model training, inference generation, and performance drift. Anomalies are identified by comparing real-time telemetry to historical benchmarks. Example scenarios include: a sudden drop in model confidence levels; a data fingerprint hash mismatch with the attested source, and performance deviation beyond domain-specific thresholds (e.g., “confidence drift>20% across 10 inference cycles triggers rollback”). Upon detecting such deviations, the system can toll back to a previously attested model; Quarantine suspect datasets; Revalidate inference workflows; and Alert human reviewers for oversight.

### Multi-Layered Blockchain for Enhanced Security and Scalability

Technical Process: A multi-layered blockchain approach is utilized where different layers handle various aspects of data lineage and model tracking. For instance, one layer manages data integrity, another handles data lineage, and a third ensures compliance and auditing. Each layer is optimized for its specific function, improving security, scalability, and performance. This separation of concerns within the blockchain architecture ensures that the system can scale efficiently and maintain high security standards.

The multi-layered blockchain approach refers to a design that uses distinct blockchain chains or segments to store categorized information about the AI lifecycle, rather than a monolithic, one-size-fits-all ledger. Each layer captures a different class of lineage-critical event:

Layer 1 (Operational Events): Tracks model versioning, data set usage, deployment timestamps, and model ownership.

Layer 2 (Inference Telemetry): Records inference output, model confidence scores, and metadata such as latency or failure flags.

Layer 3 (Anomaly and Correction Logs): Documents when anomalies are detected and how the system responded, including which corrective rule was triggered.

Layer 4 (Governance Metadata): Stores compliance certifications, audit outcomes, and policy validations.

These layers can be implemented in logically separated chains or as indexed channels within a permissioned blockchain. This structure enhances scalability, simplifies querying, and ensures different types of events can be governed according to their specific compliance needs.

### Federated Learning Telemetry and Reasoning System Technical Process:

The system integrates with existing federated learning frameworks, such as SageMaker and TensorFlow Federated, to provide comprehensive tracking and visibility of federated learning processes. It allows users to specify the federated relationships between models, their data sources, and training environments. The system automatically receives telemetry data from these models for each inference, adjustment, training session, and federated reintegration at the source model. This ensures detailed visibility, tracking, and attestation of the entire federated learning lifecycle.

Integration with Federated Learning Frameworks

Framework Support: The system is designed to work with federated learning frameworks like SageMaker and TensorFlow Federated. It does not replicate the functionalities of these frameworks but complements them by adding robust tracking and reasoning capabilities.

API Interaction: The system provides APIs for federated learning frameworks to log training, inference, and adjustment data.

### Telemetry Data Collection

Automated Telemetry: The system automatically collects telemetry data from federated models, capturing details of each inference, weight adjustment, training session, and reintegration into the source model.

Data Logging: All telemetry data is logged on a blockchain ledger, ensuring immutability and transparency. This includes metadata such as the time of inference, the data source, and the specific model version used.

### Reasoning Over Telemetry

Anomaly Detection: The system applies machine learning algorithms to the collected telemetry data to detect anomalies. Anomalies can include unexpected changes in model weights, unusual inference patterns, or deviations in training results.

Alerts and Alarms: When an anomaly is detected, the system raises alerts or alarms. These alerts are logged and can be sent to relevant stakeholders through various channels (e.g., email, SMS, dashboards).

### Data Visualization

Visual Lineage Tracking: The system provides a user-friendly interface for visualizing the lineage of federated learning models and their contributing data sets. This includes details of training sessions, inferences, adjustments, and detected anomalies.

Interactive Dashboards: Users can interact with dashboards to explore the telemetry data, filter by various criteria, and view detailed reports.

Integration with MLOps Pipelines

Event Issuance: The system issues events based on the telemetry data and detected anomalies. These events can be consumed by existing MLOps pipelines for further processing.

API for Federated Learning Platforms: SageMaker and TensorFlow Federated can check with the system through an API to determine if federated learning should proceed based on the latest telemetry data and anomaly reports.

The disclosed AI Lineage system delivers significant value to organizations, governments, and industry verticals requiring detailed AI model explanations, transparency, and attestation. The disclosed AI Lineage system offers several advantages including-Enhanced Transparency and Explainability: Organizations gain a robust ability to articulate clearly how AI model decisions are derived, significantly improving trust and regulatory compliance; Comprehensive Compliance and Regulatory Alignment: Governments and regulatory bodies benefit from improved visibility into AI processes, facilitating straightforward adherence to evolving compliance mandates such as GDPR, CCPA, and the EU AI Act; and Improved Decision-making Integrity: Industry verticals such as finance, healthcare, defense, and insurance can reliably verify the veracity of datasets and the accuracy of AI model inferences, enhancing overall operational integrity.

The disclosed AI Lineage system addresses critical limitations inherent in existing fragmented platforms by integrating intuitive user interfaces, comprehensive lineage tracking, robust model management, and advanced security and compliance features. Unlike current solutions that often provide incomplete or disconnected lineage capabilities, the disclosed system provides an integrated, unified, and auditable lineage infrastructure, significantly enhancing user efficiency and regulatory compliance capabilities.

The disclosed system when implemented in financial services demonstrated several improvements and benefits including auditing cycle time reduced by 40%, Lineage tracking accuracy improved by 60%, and Regulatory reporting efficiency increased by up to 50%. Moreover, by employing SHA-256 cryptographic hashing and blockchain-inspired mechanisms, the system robustly guarantees data security and integrity. The system explicitly aligns with essential regulatory frameworks such as GDPR, CCPA, and the EU AI Act, ensuring sustained compliance and future-proof relevance.

In certain implementations, disclosed is a system comprising a processor executing a plurality of modules stored in memory. These include Interface Module which allows interaction via web dashboards and APIs; Registration and Attestation Modules which handle cryptographic dataset/model registration and validation; Tracking and Lineage Modules which monitor dataset transformations, model training, and inference operations, generating cryptographic hashes; anomaly Detection and Correction Engine which monitors event streams, compares real-time metrics against thresholds, and triggers rule-based remediation (e.g., model rollback, dataset quarantine); and smart Contract Engin which executes compliance policies on-chain (e.g., inference confidence thresholds, data fingerprint verification).

In certain implementations, the disclosed system includes Federated Learning Support. Each participant node contributes local lineage entries hashed and committed to the blockchain without exposing raw data, ensuring privacy-compliant traceability.

In certain implementations, the disclosed system includes a blockchain Infrastructure which includes multiple logical layers including Operational Events Layer which tracks model training, data ingestion, deployment timestamps; Inference Telemetry Layer which logs inference results, confidence scores, latency; anomaly and Correction Layer which stores deviation events and applied remediation logic; Governance and Certification Layer which maintains auditor stamps, lineage attestations, and cross-jurisdictional compliance certifications.

The disclosed system specifically provides for improved security & compliance. The system can implement access control which includes Role-Based Access Control (RBAC) and Attribute-Based Access Control (ABAC). Regulatory monitoring adheres to GDPR, CCPA, HIPAA, and the EU AI Act. Immutable logs are stored in blockchain-validated format, enabling forensic traceability and external audit.

The disclosed system delivers a novel, scalable, and compliant solution to AI lineage management, integrating blockchain, anomaly correction, federated traceability, and automated governance enforcement. The disclosed system addresses a pressing industry need by enabling verifiable trust and transparency in AI pipelines, especially across multi-party, regulated environments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for tracking, analyzing, and managing the lineage of datasets and artificial intelligence (AI) models using blockchain technology, the system comprising:
a processor;
a memory operably coupled to the processor, the memory storing instructions which, when executed by the processor, cause the system to:
record and manage datasets and AI models as blockchain entities with unique identifiers and metadata;
attest to the authenticity and integrity of the datasets and AI models using cryptographic verification techniques; and
track changes to datasets and AI models, including data lineage, model iterations, and inference results, and record the changes as transactions on the blockchain.

2. The system of claim 1, wherein hash values of the datasets and AI models are recorded in the blockchain.

3. The system of claim 1, wherein the set of instructions comprises a multilayer blockchain architecture, wherein each layer of the multilayer blockchain architecture is configured to captures a different class of a lineage-critical event, the multilayer blockchain architecture comprises:
a first layer configured to tracks model versioning, data set usage, deployment timestamps, and model ownership;
a second layer configured to record inference output, model confidence scores, and metadata;
a third layer configured to document anomalies how the system responded to the respective anomaly, and corresponding corrective rule triggered; and
a fourth layer configured to store compliance certifications, audit outcomes, and policy validations.

4. The system of claim 3, wherein the four layers are implemented in logically separated chains or as indexed channels within a permissioned blockchain.

5. The system of claim 1, wherein the set of instructions are further configured to cause the system to:
render a lineage interface for enabling users to search, visualize, and query lineage of datasets and AI models.

6. The system of claim 1, wherein the set of instructions are further configured to cause the system to:
link AI models to their respective training datasets; and
record model-specific information on the blockchain.

7. The system of claim 1, wherein the set of instructions comprises dynamic anomaly detection and correction module which upon execution by the processor causes the system to:
detect anomalies in data or model lineage using machine learning algorithms trained on historical lineage data; and
apply correction rules based on detected anomalies and log the corrective actions on the blockchain.

8. A method for tracking, analyzing, and managing the lineage of datasets and artificial intelligence (AI) models using blockchain technology, the method implemented within a system comprising a processor and a memory, the method comprising:
recording and managing datasets and AI models as blockchain entities with unique identifiers and metadata;
attesting to the authenticity and integrity of the datasets and AI models using cryptographic verification techniques; and
tracking changes to datasets and AI models, including data lineage, model iterations, and inference results, and record the changes as transactions on the blockchain.

9. The method of claim 8, wherein hash values of the datasets and AI models are recorded in the blockchain.

10. The method of claim 8, wherein the method comprises:
implementing a multilayer blockchain architecture, wherein each layer of the multilayer blockchain architecture is configured to captures a different class of a lineage-critical event, the multilayer blockchain architecture comprises:
a first layer configured to tracks model versioning, data set usage, deployment timestamps, and model ownership;
a second layer configured to record inference output, model confidence scores, and metadata;
a third layer configured to document anomalies how the system responded to the respective anomaly, and corresponding corrective rule triggered; and
a fourth layer configured to store compliance certifications, audit outcomes, and policy validations.

11. The method of claim 10, wherein the four layers are implemented in logically separated chains or as indexed channels within a permissioned blockchain.

12. The method of claim 8, wherein the method further comprises:
rendering a lineage interface for enabling users to search, visualize, and query lineage of datasets and AI models.

13. The method of claim 8, wherein the method further comprises:
linking AI models to their respective training datasets; and
recording model-specific information on the blockchain.

14. The method of claim 8, wherein the method further comprises:
detecting anomalies in data or model lineage using machine learning algorithms trained on historical lineage data; and
applying correction rules based on detected anomalies and log the corrective actions on the blockchain.

15. A method for anomaly-aware AI lineage tracking comprising:
registering datasets with cryptographic hashes;
tracking transformations and model training in a multi-layered blockchain ledger;
detecting lineage anomalies via real-time machine learning models;
initiating automated correction based on predefined rules; and
recording remediation events immutably.

16. The method of claim 15, wherein blockchain entries are segmented by operational layer and implemented via permissioned distributed ledger.

17. The method of claim 15, wherein federated learning nodes contribute hashes without exposing raw datasets.

18. The method of claim 15, wherein smart contracts are triggered to enforce compliance policies.

19. The method of claim 15, further comprising a role-based user interface that adapts lineage visibility based on user attributes.
